(19) United States
(12) Patent Application Publication
(10) Pub. No.: US 2021/0042134 A1
(43) Pub. Date: Feb. 11, 2021

(54) PROVIDING NON-INVASIVE GUIDED ASSISTANCE TO A CLIENT DEVICE

(71) Applicant: Microsoft Technology Licensing, LLC, Redmond, WA (US)

(72) Inventors: Aravindan ELANGO, Bangalore (IN); Nishan NASEER, Bangalore (IN)

(21) Appl. No.: 16/533,307

(22) Filed: Aug. 6, 2019

(51) Int. Cl. G06F 9/451; G06Q 30/00; G06F 11/34

(52) U.S. Cl. CPC G06F 9/453; G06F 11/3438; G06Q 30/016

(57) ABSTRACT

The present disclosure relates to systems, methods and computer readable media for providing non-invasive guided assistance to a client device in performing a variety of tasks. For example, systems disclosed herein may enable a client device to provide a request for assistance to an administrator device. The administrator device may record a series of interactions for performing the task, which may be used to generate a walkthrough file. The walkthrough file may be provided to the client device including instructions executable on the client device for presenting the recorded series of interactions on a graphical user interface of the application on the client device. This provides a significantly improved customer service experience over conventional co-browsing sessions and/or FAQ articles intended to assist users in completing various computing tasks.

### CROSS-REFERENCE TO RELATED APPLICATIONS

[symbol]

### BACKGROUND

Recent years have seen a significant rise in the use of computing devices (e.g., mobile devices, personal computers, server devices) to perform a variety of different tasks. Indeed, as computing devices continue to improve and as new applications and software tools are developed, more and more individuals are using computing devices to perform an increased number and variety of tasks. With this increase in popularity of new devices and/or new applications, there continues to be a need for effective customer support in utilizing devices and applications.

Many conventional applications or customer-service systems provide help articles or frequently asked question (FAQ) pages to assist individuals in learning how to use unfamiliar tasks or applications. These articles and FAQ pages may provide detailed explanations of how to perform common tasks or troubleshoot problems that arise when attempting to use different applications. These articles, however, are often under-inclusive or otherwise non-representative of the types of problems that individuals encounter. Moreover, these articles are often confusing to less experienced users of various applications.

As an alternative to providing articles of FAQ pages, many conventional customer-service systems allow users and customer service representatives to engage together via a co-browsing session. For example, conventional systems may implement screensharing technology that allows a customer service representative to view or control a view of a customer screen to resolve questions or assist a customer in performing various functions. These co-browsing sessions, however, often involve computationally prohibitive technology that requires specialized software, higher performing computing devices, and/or a reliable internet connection between all parties involved in the co-browsing session to function correctly. Moreover, co-browsing often involves privacy issues, as a customer service representative can see a customer's screen and may even access files on a customer device.

These and other problems exist with regard to providing customer assistance in performing tasks on computing devices.

### BRIEF DESCRIPTION OF THE DRAWINGS

FIG. 1 illustrates an example environment of a system that enables an administrator device to provide non-invasive guided assistance to a client device in accordance with one or more embodiments.

FIG. 2 illustrates an example set of interactions between devices and platforms of an environment for providing non-invasive guided assistance to a client device in accordance with one or more embodiments.

FIGS. 3A-3F illustrate example graphical user interfaces of a client device and administrator device for providing guided assistance to a client device in performing a task in accordance with one or more embodiments.

FIGS. 4A-4B illustrate example presentations of interactions for performing a task on an application in accordance with one or more embodiments.

FIG. 5 illustrates another example set of interactions between devices and platforms of an environment for providing non-invasive guided assistance to a client device in accordance with one or more embodiments.

FIG. 6 illustrates an example method for generating and providing a walkthrough file to a client device for use in presenting a set of interactions for performing a task on an application in accordance with one or more embodiments.

FIG. 7 illustrates an example method for obtaining and presenting interactions for performing a task on an application in accordance with one or more embodiments.

FIG. 8 illustrates certain components that may be included within a computer system.

### DETAILED DESCRIPTION

The present disclosure is generally related to an environment that facilitates providing non-invasive guided assistance in performing a task on a client device. In particular, as will be discussed in further detail below, a chat platform may be used to facilitate communication between a client device and an administrator device to enable a user of the client device to request assistance in performing a task on an application (e.g., a software application, web application) running on the client device. The administrator device may record a set of interactions in connection with performing the indicated task and generate a walkthrough file that includes information (e.g., instructions and/or metadata) that enables the set of interactions to be presented on the client device. Upon receiving the walkthrough file, the client device may provide a display of the interactions being executed on the client device.

The present disclosure includes a number of practical applications that provide benefits and/or solve problems associated with non-invasive guided assistance in performing a variety of tasks on a client device. For example, as will be discussed in further detail herein, systems described herein facilitate generating a walkthrough that includes instructions for both performing a task of the application on the client device while allowing a user to additionally view a series of interactions as they appeared on an administrator device. This allows a task to both be performed correctly as well as assisting the user in understanding how the task was performed.

Furthermore, one or more embodiments described herein involve providing multiple selectable options for differentiating how the interactions may be presented on a graphical user interface of the application on the client device. For example, in one or more implementations, a client device may playback the interactions as they are executed on the client device that a user may view any number of times. As another example, and as will be discussed in further detail below, a client device may provide instructional indicators (e.g., graphical elements) via the graphical user interface of the application on the client device that enables a user to receive step-by-step guidance in performing each individual interaction as previously recorded on an administrator device.

The systems described herein provide a less invasive and less computationally prohibitive approach to guided assistance in performing application tasks than conventional co-browsing techniques. For example, by providing a walkthrough file including instructions and metadata, performance of a task may be presented and executed on a client device without providing non-secure or unrestricted access to the client device (or display of the client device) to a customer service representative or other individual. Moreover, where the walkthrough file is a JavaScript Object Notation (JSON) object or other common file-type executable on the client devices (or by the application on the client device), client devices do not need to have access to expensive and/or computationally prohibitive co-browsing software or other screen-sharing applications.

Furthermore, the systems described herein enable walkthrough files to be accessible to users of client devices at any time. For example, where a user needs to perform the same task at a later date, the client device can simply access a chat log, a received email, text, or other communication, or query a database or queue of walkthrough files to identify the relevant walkthrough file. The client device may therefore recall instructions from walkthrough files without following up or re-engaging with customer service representatives of other administrator devices.

Moreover, even where a client device again engages with customer service representatives to request assistance in performing the same tasks as previously requested, an administrator may similarly access a database or collection of previously generated walkthrough files to identify a set of interactions that may be performed in completing a given task. In this way, an administrator may identify and provide access to walkthrough files without again recording the same set of interactions over and over on the administrator device.

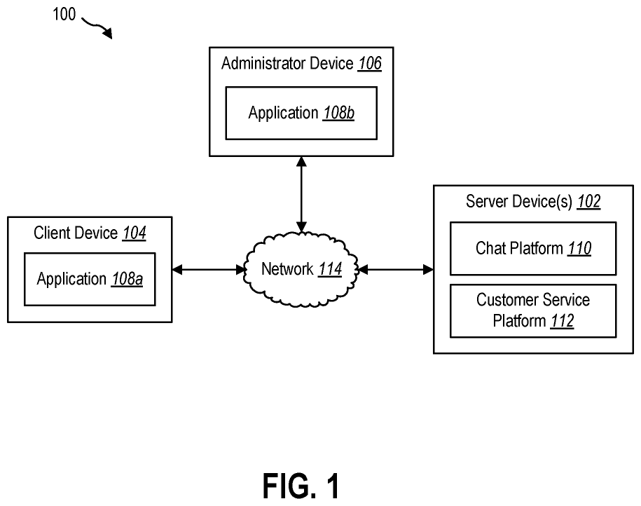

Additional detail will now be provided regarding systems and methods described herein in relation to illustrative figures portraying example implementations. For example, FIG. 1 illustrates an example environment 100 in which an administrative device may leverage services of a chat platform and customer service platform to provide non-invasive guided assistance to facilitate performing a task on a client device. As shown in FIG. 1, the environment 100 includes one or more server device(s) 102, a client device 104, and an administrator device 106. As further shown, the client device 104 and administrator device 106 may have applications 108a-b thereon. In one or more embodiments, the application 108a on the client device 104 refers to a similar or identical application 108b on the administrator device 106.

As used herein, the applications 108a-b may refer to software or programs that have been developed to perform any number of functions or activities on one or more computing devices. The applications 108a-b may refer to software installed on the respective devices or software that is accessible via one or more remote computing devices (e.g., web software or cloud-based services). In one or more embodiments, the application 108a refers to a web browser or web application accessible via a web browser on the client device 104. Alternatively, the application 108a may refer to a software application installed on and operating locally on the client device 104. Examples of applications include word processors, spreadsheet programs, accounting applications, web browsers, email clients, media viewing software, media editing software, file viewing applications, gaming applications, or any application with which a user may interact in performing a task. In one or more embodiments, the application 108a refers to a software suite or collection of related applications accessible via a common platform on a server or on the client device 104.

In one or more embodiments, the applications 108a-b provide graphical user interfaces of the respective applications 108a-b on display devices of the respective computing devices (e.g., the client device 104 and the administrator device 106). For example, a first application 108a on the client device 104 may provide a graphical user interface of the first application 108a via a display of the client device 104 while a second application 108b on the administrator device 106 provides a graphical user interface of the second application 108b on the administrator device 106. Alternatively, where the applications 108a-b refer to the same application on different devices, a graphical user interface of the application may refer to an interface on the client device 104 or on the administrator device 106. As will be discussed in further detail below, users of the respective devices may interact with the applications 108a-b via the graphical user interfaces of the applications 108a-b in performing one or more tasks on the applications 108a-b on the respective computing devices 104-106.

As further shown in FIG. 1, the server device(s) 102 may include a number of platforms including a chat platform 110 and a customer service platform 112. As will be discussed in further detail, the chat platform 110 provides services associated with connecting a user of the client device 104 with a user of the administrator device 106. For example, the chat platform 110 may refer to a service (e.g., a cloud-based service) that operates in connection with the applications 108a-b on the client device 104 and administrator device 106 and which allows the client device 104 to provide a request for assistance in performing a task to an administrator device 106.

As will also be discussed in further detail below, the customer service platform 112 provides one or more services to enable the administrator device 106 to provide assistance in performing a task to a user of the client device 104. For example, the customer service platform 112 may record or otherwise enable the administrator device 106 to record interactions performed in connection with the application 108b on the administrator device 106. The customer service platform 112 may also generate and maintain walkthrough files including instructions for presenting the recorded interactions on the client device 104 as well as enable the client device 104 to obtain access to one or more of the walkthrough files.

FIG. 1 illustrates one example in which the respective platforms 110-112 are implemented on the same server device or the same network of server devices. In one or more embodiments, the chat platform 110 is implemented on a different server device (or multiple server devices) as the customer service platform 112. Moreover, one or both of the chat platform 110 and the customer service platform 112 may operate in conjunction with the applications 108a-b on the client device 104 and/or administrator device 106.

As shown in FIG. 1, the server device(s) 102, client device 104, and administrator device 106 may communicate with each other directly or indirectly through a network 114. The network 114 may include one or multiple networks and may use one or more communication platforms or technologies suitable for transmitting data. The network 114 may refer to any data link that enables the transport of electronic data between devices and/or modules of the environment 100. The network 114 may refer to a hardwired network, a wireless network, or a combination of a hardwired and a wireless network. In one or more embodiments, the network 114 includes the Internet.

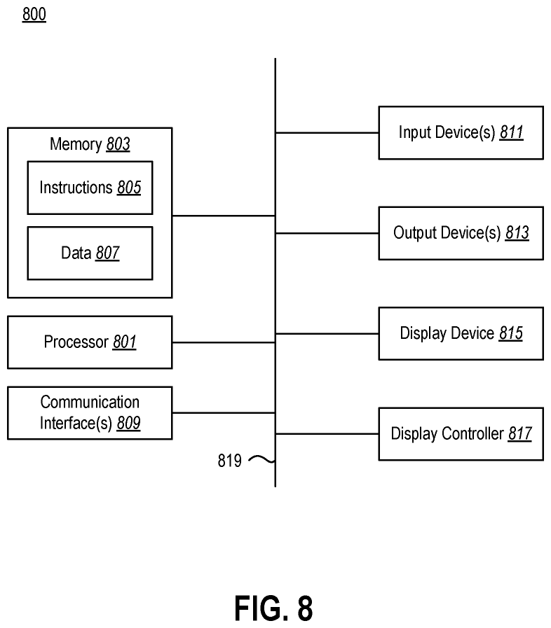

The client device 104 and the administrator device 106 may refer to various types of computing devices. For example, the client device 104 and/or administrator device 106 may refer to mobile devices such as a mobile telephone, a smartphone, a personal digital assistance (PDA), a tablet, or a laptop. Additionally, or alternatively, the client device 104 and/or administrator device 106 may refer to a non-mobile device such as a desktop, computer, server device, or other non-portable computing device. The server device(s) 102 may similarly refer to various types of computing devices. Each of the devices illustrated in FIG. 1 may include features and functionality described below in connection with FIG. 8.

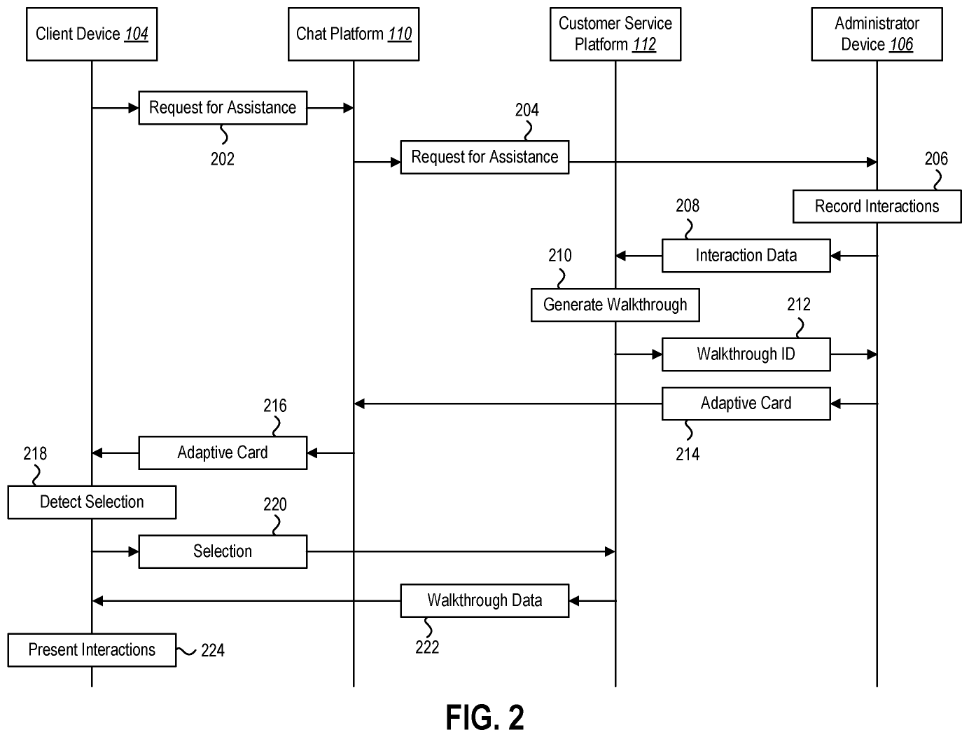

Additional detail will now be given in connection with an example implementation in which the administrator device 106 leverages capabilities of the chat platform 110 and customer service platform 112 to provide non-invasive guided assistance to perform a task on an application (e.g., the application 108a) on the client device 104. For example, as shown in FIG. 2, the client device 104 may provide 202 a request for assistance to a chat platform 110. This may involve opening a chat application or activating a chat feature of the application (e.g., a plug-in provided or hosted by the chat platform 110).

The client device 104 may provide a request for assistance in a variety of ways. For example, in one or more embodiments, the request may include a message composed by a user of the client device 104 (e.g., within a chat window) including a description of a task or user-composed information about the request. In one or more implementations, the request may be provided via a form, survey, or questionnaire in which a user of the client device 104 indicates information about the task to be performed. The request may include information indicating the application, details about the task, or a selection of one or more options provided to assist the chat platform 110 in determining or otherwise identifying an administrator device 106 capable of providing assistance in performing the task.

As shown in FIG. 2, upon receiving the request for assistance, the chat platform 110 may relay 204 the request for assistance to an identified administrator device 106. For example, the chat platform 110 may apply a set of rules or policies to the request for assistance received from the client device 104 to identify an administrator device 106 associated with a representative having expertise with a particular application or otherwise identify an administrative device 106 having access to an application on the administrator device (e.g., application 108b) similar to or the same as the application on the client device 104.

In one or more embodiments, the administrator device 106 provides a chat window or other mechanism to enable a user of the administrator device 106 to interact directly with the user of the client device 104 via the chat platform 110. This may involve providing a text, video, or audio chat window that enables the users of the respective devices 104-106 to interface. In this way, the user of the administrator device 106 may obtain additional information to better understand the task that the user of the client device 104 needs assistance in performing.

As shown in FIG. 2, the administrator device 106 may record 206 interactions performed on the administrator device 106 in connection with performing the task associated with the received request. For example, the administrator device 106 may include an application (or the customer service platform 112 may provide functionality) that enables the administrator device 106 to record or otherwise track a series of inputs received by the administrator device 106. As will be discussed in further detail below, the administrator device 106 may track a series of interactions with an application on the administrator device 106 including tracked clicks, touch inputs, keystrokes, and any other type of input received by the administrator device 106 during a time period that the administrator device 106 is set to record the interactions.

In one or more embodiments, the administrator device 106 provides 208 the interaction data including information about the recorded interactions to the customer service platform 112. The interaction data may include an indication of the specific inputs (e.g., keystrokes, clicks, touch inputs). In addition, the interaction data may include a location on a graphical user interface of an application for each of the detected inputs. Moreover, the interaction data may include the specific values entered (e.g., letters/numbers/symbols) in performing the respective interactions. In one or more embodiments, the interaction data includes a representation of the timing of inputs, which may include a simple order of the inputs received or a real-time representation of the inputs as provided by a user of the administrator device 106.

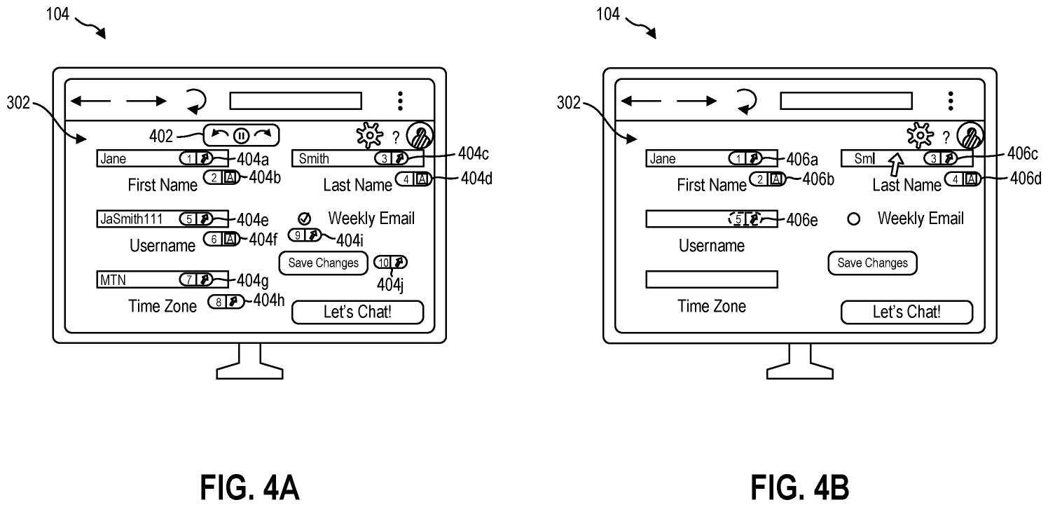

As shown in FIG. 2, the customer service platform 112 may generate 210 a walkthrough file based on the interaction data. For example, the customer service platform 112 may generate a JSON object or other type of file compatible with the applications on the client device 104 and administrator device 106 including metadata indicating the recorded interactions and associated information (e.g., location of the interactions on a graphical user interface of an application). The walkthrough file may further include instructions that are executable on the client device 104 and operable in conjunction with the application that facilitate presenting the recorded interactions on the client device 104 in a variety of ways. Examples of ways in which the interactions may be presented on the client device 104 will be discussed in further detail (e.g., in connection with FIGS. 4A-4B).

Upon generating the walkthrough file, the customer service platform 112 may provide 212 a walkthrough identifier to the administrator device 106. The walkthrough identifier may include a link or other identifier that provides access to the walkthrough file. For example, the link may include a file location, a uniform resource locator (URL), a security key or token, or any other information that provides access to the client device 104 to information from the walkthrough file maintained on the customer service platform 112.

The administrator device 106 may further provide 214 an adaptive card to the chat platform 110. As used herein, an adaptive card refers to a displayable object or structure capable of being displayed on a computing device. For example, an adaptive card may include a displayable graphic or image including one or more selectable elements (e.g., links) with which a user of the client device 104 may interact in causing a presentation of the walkthrough file to be presented on a graphical user interface of an application on the client device 104.

As shown in FIG. 2, the chat platform 110 may provide 216 the adaptive card to the client device 104 for display on the client device 104. In one or more embodiments, the chat platform 110 provides the adaptive card for display within a chat window provide within a graphical user interface of the application 108a. In addition, or as an alternative, the chat platform 110 may provide the adaptive card via a text message, email, or other communication medium that a user of the client device 104 may access in obtaining instructions of the walkthrough file that facilitate presenting the interactions from the walkthrough file on the client device 104.

As shown in FIG. 2 the client device 104 may detect 218 a selection of the adaptive card. For example, the client device 104 may detect a selection of a link from one or more links provided within the adaptive card. Upon detecting the selection, the client device 104 can provide 220 an indication of the selection to the customer service platform 112. The indication of the selection may indicate the walkthrough file or include a request for access of the walkthrough file maintained on the customer service platform 112. As will be discussed in further detail below, the selection may indicate specific instructions or metadata of the walkthrough file associated with a way in which the interactions should be presented on the client device 104.

Based on the indicated selection, the customer service platform 112 may provide 222 walkthrough data to the client device 104. Providing the walkthrough data may include providing the walkthrough file (e.g., a JSON object including the interaction data) to the client device 104. In one or more embodiments, the chat platform 110 is used to provide a set of instructions from the walkthrough file maintained or otherwise stored on the customer service platform 112 that are executable on the application of the client device 104 to provide a presentation of the interactions as recorded on the administrator device 106.

As shown in FIG. 2, the client device 104 may present 224 the interactions via a graphical user interface of the application on the client device 104. As will be discussed in further detail below, the client device 104 may present the interactions by providing a replay of the interactions (e.g., in real-time) as recorded on the administrator device 106. In one or more embodiments, the client device 104 presents the interactions by providing instructional elements based on the recorded interactions (on the administrator device 106) to enable a user of the client device 104 to manually perform interactions with the client device 104 to complete the task.

The series of interactions shown in FIG. 2 is provided by way of example and may include different interactions as may serve a particular embodiment. As an example, one or more interactions relayed by the customer service platform 112 and/or chat platform 110 between the client device 104 and administrator device 106 may be delivered directly between devices rather than as specifically shown in FIG. 2. As another example, one or more communications between the administrator device 106 and the customer service platform 112 may be performed directly between the customer service platform 112 and the chat platform 110, such as when the chat platform 110 and/or customer service platform 112 are implemented on a common network of server devices (e.g., where the platforms are implemented on a common cloud computing system).

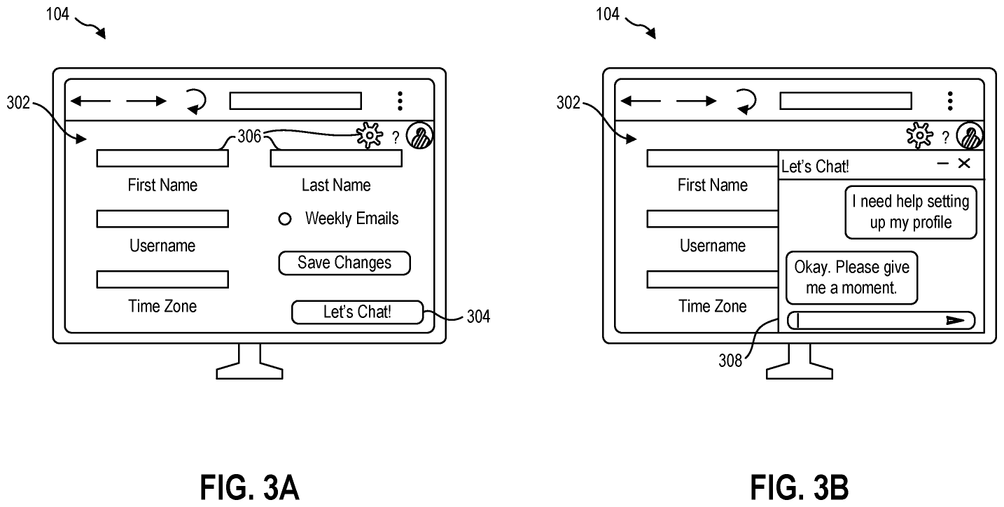

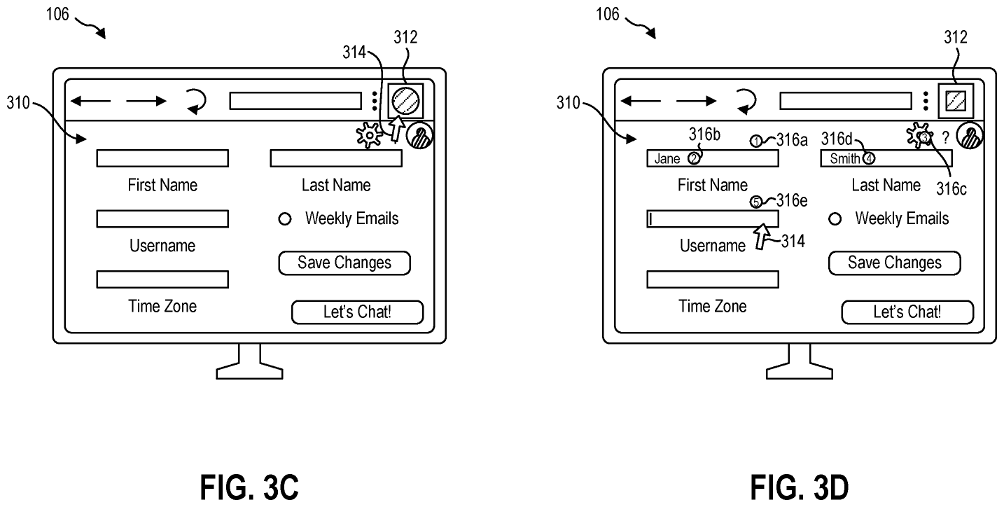

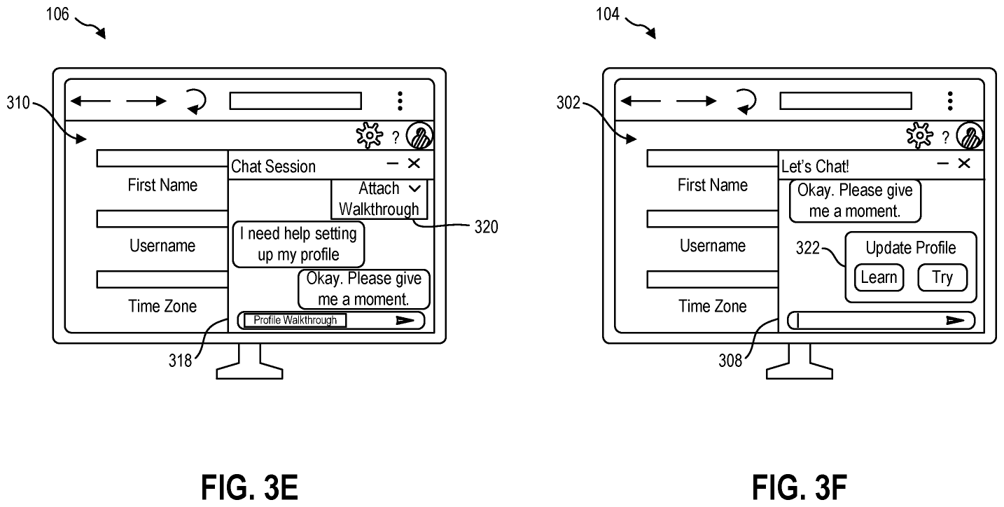

Further detail will now be given in connection with an example set of graphical user interfaces of applications (e.g., applications 108a-b) on the client device 104 and administrator device 106. In particular, FIGS. 3A-3F illustrate example graphical user interfaces demonstrating one example in which an administrator device 106 can provide non-invasive guided assistance in performing a task on an application (e.g., a web application) on the client device 104. While FIGS. 3A-3F illustrate an example in which assistance is provided for performing a task (e.g., setting up or editing a profile) on a web application, features and functionality described herein may similarly apply to providing guided assistance in performing a task on a locally stored application (or any type of software application) running on the client device 104.

For example, FIG. 3A illustrates an example graphical user interface 302 on a client device that shows an interface of a web browser or web application provided via a web browser on the client device 104. As shown in FIG. 3A, the graphical user interface 302 includes a number of graphical elements 306 that a user of the client device 104 may select to perform various functions of the application. The graphical elements 306 may include text fields for entering text, selection boxes, setting and profile icons, or any other selectable elements displayed on the client device 104.

As further shown, the graphical user interface 302 may include a chat icon 304. The chat icon 304 may refer to an icon provided by a chat platform 110 operating in connection with the application on the client device 104. For example, the chat platform 110 may provide a plug-in, subroutine, or other instructions that enable the user of the client device 104 to open a live-chat within the graphical user interface 302 of the application to initiate a chat session with a user of an administrator device 106 or otherwise deliver a request for assistance in performing a task on the application.

In response to detecting a selection of the chat icon 304, the application (or chat platform 110) may provide a chat window 308, as shown in FIG. 3B. For example, as shown in FIG. 3B, a user of the client device 104 may activate a chat window and provide a request for assistance by typing “I need help setting up my profile.” As indicated above in connection with FIG. 2, the chat platform 110 may initiate a chat session with an administrator device 106 by providing the composed message via a corresponding chat window on an administrator device 106. As shown in FIG. 3B, the user of the administrator device 106 has responded to the request by typing “Ok. Please give me a moment,” which is displayed within the chat window 308 on the graphical user interface of the application on the client device 104.

Moving on, FIG. 3C illustrates an example administrator device 106 including a graphical user interface 310 of the application on the administrator device 106 after receiving a request for assistance in performing a task of the application. As shown in FIG. 3C, the graphical user interface 310 includes a recording element 312 and a cursor 314 with which a user of the administrator device 106 can interact to begin recording interactions with the application by the administrator device 106. In particular, a user may move the cursor 314 over the recording element 312 and select the recording element 312 to initiate recording or otherwise tracking interactions with the application on the administrator device 106.

Similar to the chat platform 110 providing the chat element, the recording element 312 may be a feature provided by or otherwise supported by the customer service platform 112. For example, the recording element 312 may include a selectable element provided over a portion of the graphical user interface 310 of an application running on the administrator device via a plug-in, subroutine, or other mechanism. Moreover, while FIG. 3C illustrates an example in which the user of the administrator device 106 initiates recording interactions by moving a cursor 314, administrator device 106 may further include a touchscreen capable of detecting a selection of the recording element 312 based on one of a variety of different touch-inputs (e.g., tap gesture, long-press gesture, swiping gesture, etc.).

FIG. 3D provides an example illustration in which an administrator device 106 records a plurality of interactions detected in connection with a graphical user interface 310 of the application on the administrator device 106. For example, in response to detecting a selection of the recording element 312, the administrator device 106 may begin recording any number of interactions (e.g., clicks, touch inputs, keystrokes) detected by the administrator device 106. In addition to detecting the interactions, the administrator device 106 may detect or otherwise track locations of the interactions with respect to the graphical user interface 310.

As shown in FIG. 3D, the administrator device 106 can detect a plurality of interactions 316a-e as received or otherwise detected by the administrator device 106. For example, as shown in FIG. 3D, the administrator device 106 can detect a first interaction 316a indicating a selection of a first text field. The administrator device 106 can further track a second interaction 316b indicating keystrokes in which a user of the administrator device 106 types a first name “Jane.” The administrator device 106 can further detect a third interaction 316c indicating a selection of a second text field. The administrator device 106 can further track a second interaction 316d indicating keystrokes in which the user of the administrator device 106 types a last name “Smith.” The administrator device 106 can further detect a fifth interaction 316e indicating a selection of a third text field. The administrator device 106 may proceed to record any number of interactions detected by the administrator device 106 throughout the process of the user of the administrator device 106 performing the requested task.

The administrator device 106 can record or otherwise track a variety of information associated with each interaction. For example, as mentioned above, the administrator device 106 can identify a location within the graphical user interface 310 of each corresponding interaction. The administrator device 106 can additionally identify a type of interaction (e.g., a click, a touch input, a keystroke or set of keystrokes). In addition, where a specific interaction includes multiple inputs, the administrator device 106 can identify groups of inputs (e.g., multiple keystrokes) to be identified or otherwise categorized as related interactions (e.g., an interaction that involves typing out a name including any number of letters or other symbols).

While FIG. 3D illustrates an example in which interactions are tracked for a single instance of a graphical user interface 310 (e.g., interactions with respect to a single webpage of a web application), the administrator device 106 can additionally track interactions across multiple applications or webpages. For example, where performing a task involves selecting links to other webpages, the administrator device 106 can track any number of interactions across different websites for use in illustrating performance of a task. In one or more embodiments, where a task involves interacting with multiple different applications (e.g., modifying settings of an operating system in conjunction with performing a task on a web application and/or locally stored application), the administrator device 106 can record interactions with any number of graphical user interfaces associated with different applications to include within a walkthrough file generated for a user of the client device 104.

As mentioned above in connection with FIG. 2, the administrator device 106 can cause a walkthrough file (or identifier of a walkthrough file) to be provided to the client device 104 for presenting the recorded interactions associated with performing the task. In particular, as discussed above, the administrator device 106 can provide any recorded data to a customer service platform 112 for use in generating a walkthrough file and providing an identifier of the walkthrough file to the administrator device 106. As shown in FIG. 3E, the administrator device 106 can cause the walkthrough file to be provided to the client device 104 by providing an identifier of the walkthrough file (e.g., received at the administrator device 106 from the customer service platform 112) via the chat platform 110.

For example, as shown in FIG. 3E, the administrator device 106 can provide a chat window 318 including similar features as the chat window 308 discussed above in connection with FIG. 3B. As shown in FIG. 3E, the chat window 318 may include a walkthrough attachment icon 320 that enables a user of the administrator device 106 to attach or otherwise provide access to the walkthrough file to the client device via the chat session. In particular, in response to detecting a selection of the walkthrough attachment icon 320, the administrator device 106 can add a walkthrough identifier within the chat window 318 to transmit to the client device 104 via the chat platform 110.

Upon receiving the walkthrough identifier (e.g., from the customer service platform 112), the administrator device 106 can include a link or other authentication for the client device 104 within the chat window 318. While FIG. 3E illustrates an example in which the user of the administrator device 106 selects a walkthrough attachment icon 320, in one or more embodiments, the user of the administrator device 106 types a file path to the walkthrough file. Indeed, it will be understood that the administrator device 106 can provide any link, file, identifier, or any digital object that provides access to a walkthrough file generated based on the series of interactions with the administrator device 106 recorded in connection with performing the task.

In one or more embodiments, the administrator device 106 generates and provides an adaptive card 322 to the client device 104 via the chat platform 110 (or via a direct connection between the client device 104 and client device 104). As shown in FIG. 3F, the client device 104 may provide a visualization of the adaptive card 322 including selectable options shown therein. As mentioned above, the adaptive card 322 may refer to any visualization of data provided to the client device 104 and displayable via the graphical user interface 302 of the client device 104. In the example shown in FIG. 3F, the adaptive card 322 includes two selectable options (e.g., a “learn” option and a “try” option). Other embodiments may include other selectable options.

Each of the selectable options of the adaptive card 322 may correspond to a way in which the recorded interactions may be presented on the client device 104. Indeed, each of the selectable options may refer to discrete instructions, metadata, or information recorded by the administrator device 106 that facilitate a certain presentation of interactions on the client device 104. By way of example, and as will be discussed below in connection with FIG. 4A, the “learn” option may correspond to instructions or a portion of the walkthrough file that causes a playback of the plurality of interactions on the client device 104. In addition, and as will be discussed below in connection with FIG. 4B, the “try” option may correspond to instructions or a portion of the walkthrough file that provides instructional elements via the graphical user interface 302 of the client device 104 to guide a user of the client device 104 to perform the interactions and successfully perform the task recorded by the administrator device 106.

FIG. 4A illustrates an example presentation of the recorded interactions in response to a selection of the “learn” option from the adaptive card 322. For example, in response to detecting a selection of the “learn” option, the client device 104 can receive a walkthrough file and/or access specific instructions from the walkthrough file and initiate a playback of the interactions detected by the administrator device 106. As shown in FIG. 4A, the client device 104 can provide playback controls 402 via the graphical user interface 302 of the client device 104 that enable a user of the client device 104 to control playback of the interactions. For example, a user can playback the interactions in real-time as recorded on the administrator device by selecting a “play” option. Alternatively, the user of the client device 104 can iteratively click backward or forward through each of the interactions (e.g., by interacting with corresponding forward and backward controls, as shown within the playback controls 402 in FIG. 4A).

In one or more embodiments, the client device 104 executes instructions from the walkthrough file to perform the interactions from the walkthrough file. For instance, in the example shown in FIG. 4A, the client device 104 can perform each of the tracked interactions. In addition, the client device 104 can provide interaction icons 404a-j indicating each of the tracked interactions. The interaction icons 404a-j can be displayed at the same time as the interactions are performed/shown. Alternatively, the interaction icons 404a-j may appear all at once while the user of the client device 104 watches as the client device 104 executes each of the interactions.

Specifically, as shown in the example of FIG. 4A, the client device 104 can provide (e.g., display) a first interaction icon 404a associated with a selection of a first name field. The client device 104 may provide a second interaction icon 404b associated with keystrokes used in typing a first name. The client device 104 may provide a third interaction icon 404c associated with a selection of a last name field. The client device 104 can provide a fourth interaction icon 404d associated with keystrokes used in typing a last name. The client device 104 may further provide a fifth interaction icon 404e indicating a selection of a username field. The client device 104 can provide a sixth interaction icon 404f indicating keystrokes used in typing a username. The client device 104 can provide a seventh interaction icon 404g indicating a selection of a time zone field. The client device 104 can further provide an eighth interaction 404h indicating a selection of a time zone (e.g., from a dropdown menu rather than typing it out). The client device 104 can further provide a ninth interaction icon indicating a selection of a preference to receive weekly emails. The client device 104 can further provide a tenth icon indicating a selection of a “save changes” button, which may conclude performance of the task.

In this example, the walkthrough file may include specific information about the user of the client device 104. For example, where the user is a registered user of the customer service platform 112 or provides information to the user of the administrator device 106, the walkthrough file may include information specific to the user such that presenting the playback of the recorded interactions also involves performing the respective task for which the user has requested assistance. Alternatively, in one or more embodiments, the administrator device provides sample information (e.g., generic names, usernames, etc.) that simply provide an example for the user of the client device 104 to observe in viewing how the task may be performed for a hypothetical individual associated with the sample data entered into the respective fields. It will be appreciated that other tasks need not necessarily relate to providing personal information about a user and may be applicable to any user of an application.

FIG. 4B illustrates another example presentation in accordance with one or more embodiments. In particular, in response to detecting a selection of the “try” option from the adaptive card 322 shown in FIG. 3F, the client device 104 can provide a presentation that involves instructional indicators displayed at corresponding locations of the graphical user interface 302 assist the user of the client device 104 in performing the recorded interactions manually. Each of the instructional indicators may be similar to the interaction icons discussed above in connection with FIG. 4A.

As shown in FIG. 4B, the client device 104 can provide the instructional indicators as the user of the client device 104 performs the respective interactions. For example, in response to detecting a selection of the “try” icon, the client device 104 can provide the graphical user interface 302 and a first instructional indicator 406a at a location corresponding to the first name text field. The first instructional indicator 406a may indicate a type of input (e.g., a cursor selection, touch input) associated with selecting the first name text field. The client device 104 may then monitor interactions with the graphical user interface 302 to determine whether the indicated interaction is performed correctly.

Upon detecting an input corresponding to the first instructional indicator 406a, the client device 104 can provide a second instructional indicator 406b indicating an input type (e.g., keystrokes) to indicate that the user of the client device 104 should begin typing one or more values corresponding to the first name field. The user may then enter a first name in accordance with the second instructional indicator 406b. In one or more embodiments, the client device 104 may remove the first instructional indicator 406a in response to detecting input associated with the second instructional indicator 406b. Alternatively, the client device 104 may continue to provide instructional indicators (e.g., as shown in FIG. 4B) as the interactions are performed by the client device 104.

Based on detecting an interaction corresponding to the second instructional indicator 406b, the client device 104 can provide a third instructional indicator 406c indicating an input type (e.g., a selection) to indicate that the user of the client device 104 should select the last name field. In response to detecting a selection of the last name field, the client device 104 can provide a fourth instructional indicator 406d indicating that the user should begin typing a last name into the last name field. Upon detecting an interaction associated with typing the last name into the last name field, the client device 104 can provide a fifth instructional indicator 406e associated with selecting the username field. The client device 104 can proceed to provide any number of instructional indicators until each of the interactions of the task have been performed.

As mentioned above, each of the instructional indicators may be displayed or otherwise provided based on detected inputs received by the client device 104 in connection with one or more previous interactions. In one or more embodiments, the client device 104 provides a subsequent instructional indicator based on successful completion of a preceding interaction. Alternatively, in one or more embodiments, the client device 104 provides an indicator (e.g., a dashed or semi-opaque indicator) to forecast the next interaction to a user in response to detecting that the user of the client device 104 has begun performing an interaction. For example, as illustrated in FIG. 4B, the client device 104 may provide a dashed, shaded, or visibly distinct fifth instructional indicator 406e upon detecting a first keystroke or initiation of the interaction associated with the fourth instructional indicator 406d.

Where a client device 104 detects an incorrect input or other interaction with the graphical user interface 302 at an incorrect location (e.g., not corresponding to a displayed instructional indicator), the client device 104 may provide one or more error indicators to direct the user to perform the interactions in the same order as recoded by the administrator device 106. For example, if the user of the client device 104 selects the time zone field prior to the first or last name field, the client device 104 may cause an indicator corresponding to the expected input/interaction to flash or otherwise indicate (e.g., via a visual or audio prompt) a next interaction that the user should perform. Where the interaction stretches across multiple interfaces (e.g., different webpages) or where the next interaction is not currently displayed on the screen, the client device 104 may provide an indication to assist the user of the client device 104 in navigating to the correct location within the graphical user interface 302.

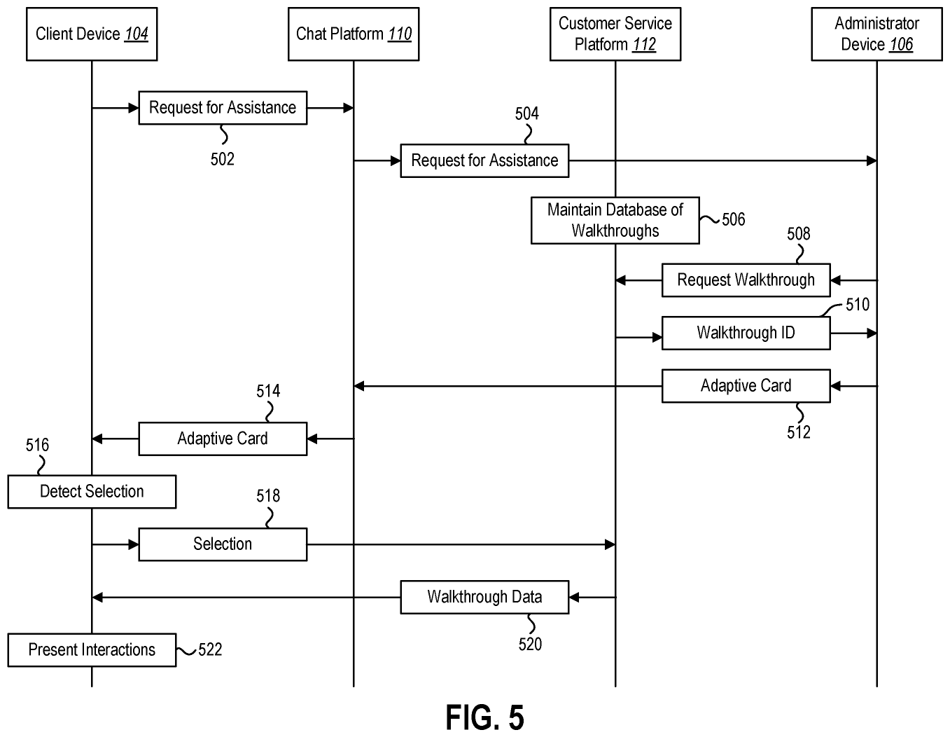

FIG. 5 illustrates another example implementation for providing non-invasive guided assistance to a client device 104 in accordance with one or more embodiments. In particular, as shown in FIG. 5, the client device 104 can provide 502 a request for assistance to the chat platform 110. The chat platform may additionally relay 504 or otherwise provide the request for assistance to an identified administrator device 106. The acts 502-504 of providing the request and relaying the request to the administrator device 106 may include similar features as corresponding acts 202-204 of providing the request and relaying the request discussed above in connection with FIG. 2.

As shown in FIG. 5, the customer service platform 112 may maintain 506 a database of walkthrough files. For example, as the administrator device 106 records performance of various tasks for an application (or for multiple different applications), the customer service platform 112 may compile a database of walkthrough files for use in assisting users of various devices in performing similar tasks. For example, in the example discussed above in connection with FIG. 2, in addition to generating the walkthrough file for distributing to the client device 104, the customer service platform 112 may store a copy of the walkthrough on a server storage that the client device 104 and/or administrator device 106 may request at a subsequent time.

As shown in FIG. 5, the administrator device 106 may provide 508 a request for a walkthrough file from the customer service platform 112. In particular, based on information obtained from the client device 104 (e.g., via a chat hosted by the chat platform 110), the administrator device 106 may provide a request for a walkthrough corresponding to a task that has previously been stored by the customer service platform 112. The administrator device 106 may provide the request by selecting a walkthrough from a menu or collection of walkthroughs. For instance, the administrator device 106 may navigate a database of common walkthroughs or send a message to other administrative devices requesting similar types of walkthroughs.

In response to the request, the customer service platform 112 can provide 510 a walkthrough identifier. The customer service platform 112 may provide any identifier or information to be passed to the client device 104 for providing access to the walkthrough file. The act 510 of providing the walkthrough identifier may be similar to the act 212 of providing the walkthrough identifier discussed above in connection with FIG. 2.

As shown in FIG. 5, the customer service platform 112 can additionally perform similar acts as discussed above in connection with FIG. 2 to enable the client device 202 to obtain instructions or data associated with performing the task in accordance with a recorded plurality of interactions (e.g., by the administrator device 106 or other administrator device in communication with the customer service platform 112). For example, as shown in FIG. 5, the administrator device 106 can provide 512 an adaptive card to a chat platform 110. As further shown, the chat platform 110 can provide 514 the adaptive card to the client device 104. The client device 104 may then detect 516 a selection shown within a display of the adaptive card. The client device 104 may provide 518 the selection to the customer service platform 112. The customer service platform 112 may provide 520 walkthrough data (e.g., the walkthrough file and/or instructions corresponding to the detected selection) to the client device 104. The client device 104 may then present 522 the interactions via a graphical user interface on the client device. 104. Each of the acts 512-522 may include similar features as the corresponding acts 214-224 discussed above in connection with FIG. 2.

While FIG. 5 illustrates an example in which the administrator device 106 provides the request for a walkthrough file, one or more embodiments may involve the client device 104 interacting with and providing a request for a walkthrough file from the customer service platform 112. For example, rather than re-engaging with a customer service representative as part of the process of obtaining the walkthrough file, the customer service platform 112 may allow the client device 104 to interact with the customer service platform 112 and access a database of walkthrough files that have been created for other customers. This may include accessing a webpage or index of walkthrough files (e.g., similar to a collection of FAQ articles) including links to walkthrough files capable of presenting interactions on the client device 104 in a number of ways as discussed above.

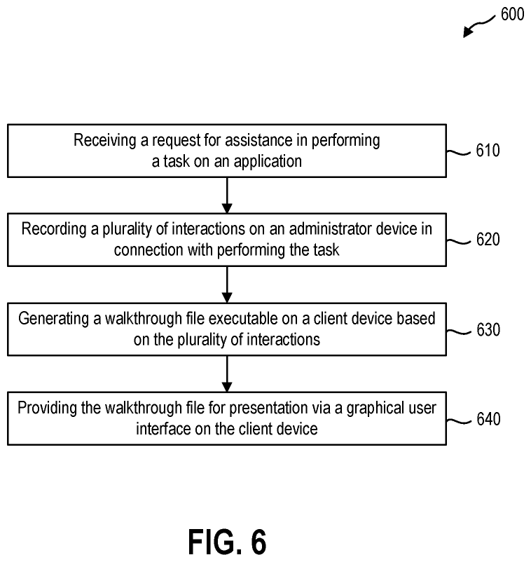

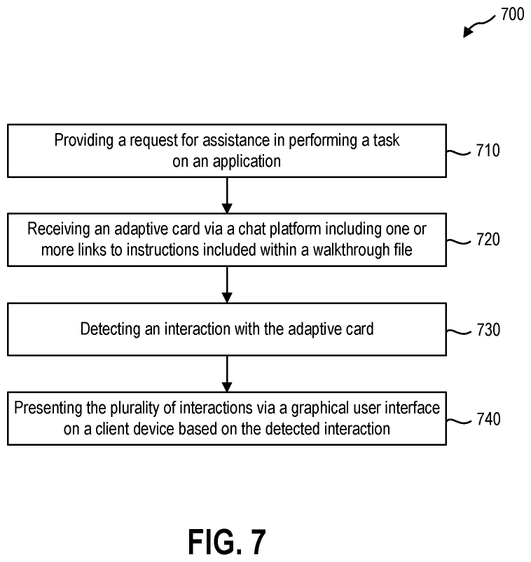

Turning now to FIGS. 6-7, these figures illustrate example flowcharts including series of acts for providing non-invasive guided assistance for performing tasks of one or more applications on a client device. While FIGS. 6-7 illustrates acts according to one or more embodiments, alternative embodiments may omit, add to, reorder, and/or modify any of the acts shown in FIGS. 6-7. The acts of FIGS. 6-7 can be performed as part of a method. Alternatively, a non-transitory computer-readable medium can include instructions that, when executed by one or more processors, cause a computing device (e.g., a server device and/or client device) to perform the acts of FIGS. 6-7. In still further embodiments, a system can perform the acts of FIGS. 6-7.

FIG. 6 illustrates a series of acts 600 for providing non-invasive guided assistance to a client device. As shown in FIG. 6, the series of acts 600 includes an act 610 of receiving a request for assistance in performing a task on an application. In one or more embodiments, the act 610 includes receiving, at an administrator device, a request for assistance in performing a task on an application, the request for assistance originating from a client device. In one or more embodiments, the series of acts 600 includes establishing a connection between the client device and the administrator device via a chat platform operating in conjunction with the application on the client device. In one or more implementations, the request for assistance in performing the task is received from the client device via the chat platform. In one or more embodiments, the application includes one or more of a web application hosted by a web server and presented on the client device or a local application stored on the client device.

As further shown, the series of acts 600 includes an act 620 of recording a plurality of interactions on an administrator device in connection with performing the task. In one or more embodiments, recording the plurality of interactions includes tracking a series of inputs by a user of the administrator device, the series of inputs including one or more clicks and keystrokes in connection with a graphical user interface of the application on the administrator device. In one or more implementations, recording the plurality of interactions further includes tracking a location of the series of inputs on the graphical user interface of the application on the administrator device.

As further shown, the series of acts 600 includes an act 630 of generating a walkthrough file executable on a client device based on the plurality of interactions. For example, the act 630 may include generating a walkthrough file executable on the client device where the walkthrough file includes information that indicates the recorded plurality of interactions associated with performing the task. In one or more embodiments, generating the walkthrough file includes generating a JavaScript Object Notation (JSON) object including the information from the walkthrough file. In one or more implementations, the information from the walkthrough file includes instructions executable on the client device for presenting the plurality of interactions via the graphical user interface of the application on the client device. Further, in one or more embodiments, generating the walkthrough file includes providing the recorded plurality of interactions to a customer service platform and receiving an identifier of the walkthrough file generated by the customer service platform to provide to the client device.

As further shown, the series of acts 600 includes an act 640 of providing the walkthrough file for presentation via a graphical user interface on the client device. For example, the act 640 may include causing information from the walkthrough file to be provided to the client device for presenting the plurality of interactions via a graphical user interface of the application on the client device.

In one or more embodiments, causing the walkthrough file to be provided includes providing an adaptive card including one or more selectable options associated with providing one or more corresponding presentations of the plurality of interactions via the graphical user interface of the application. The one or more selectable options may include a first selectable option associated with a first presentation of the plurality of interactions in which the plurality of interactions is executed on the client device without detecting inputs associated with the plurality of interactions from a user of the client device. The one or more selectable options may further include a second selectable option associated with a second presentation of the plurality of interactions in which instructional indicators for each interaction of the plurality of interactions are provided via the graphical user interface of the application on the client device.

In one or more embodiments, the series of acts 600 includes causing a copy of the walkthrough file to be stored on a database including a plurality of walkthrough files associated with respective tasks for the application. In one or more implementations, the series of acts 600 includes, in response to receiving a subsequent request for assistance in performing the task on the application on an additional client device, providing the walkthrough file to the additional client device for presenting of the plurality of interactions via a graphical user interface of the application on the additional client device.

FIG. 7 similarly illustrates a series of acts 700 for providing non-invasive assistance to a client device. As shown in FIG. 7, the series of acts 700 includes an act 710 of providing a request for assistance in performing a task on an application. For example, the act 710 may include providing, to an administrator device via a chat platform, a request for assistance in performing a task on an application on a client device. Providing the request may include providing information associated with the task and the application for use in identifying the administrator device having access to the application.

As further shown, the series of acts 700 may include an act 720 of receiving an adaptive card via a chat platform including one or more links to instructions included within a walkthrough file. For example, in one or more embodiments, the act 720 includes receiving, from the administrative device via the chat platform, an adaptive card including one or more links to instructions from a walkthrough file, wherein the instructions are executable on the client device to cause the client device to present a plurality of interactions for performing the task.

In one or more embodiments, the one or more links include a selectable link to the instructions of the walkthrough file that, when executed on the client device, cause the client device to present the plurality of interactions via the graphical user interface of the application on the client device without detecting inputs corresponding to the plurality of interactions from a user of the client device. In one or more implementations, the one or more links include a selectable link to the instructions of the walkthrough file that, when executed on the client device, cause the client device to provide a series of instructional indicators at locations within the graphical user interface of the application on the client device corresponding to locations of the plurality of interactions when recorded on the administrator device or another administrator device. Providing the series of instructional indicators may include providing a first instructional indicator at a first location within the graphical user interface of the application on the client device and providing, in response to detecting a first interaction with the client device at the first location in accordance with the first instructional indicator, a second instructional indicator at a second location within the graphical user interface of the application on the client device.

The series of acts 700 may further include an act 730 of detecting an interaction with the adaptive card. For example, the series of acts 700 may include detecting an interaction with one or more links provided via the adaptive card. In one or more embodiments, the one or more links include a first selectable link to first instructions of the walkthrough file that, when executed on the client device, cause the client device to present the plurality of interactions via the graphical user interface of the application without receiving input corresponding to the plurality of interactions from a user of the client device. The one or more links may further include a second selectable link to second instructions of the walkthrough file that, when executed on the client device, cause the client device to provide a series of instructional indicators at locations within the graphical user interface of the application on the client device associated with performing the task

Further, the series of acts 700 may include an act 740 of presenting the plurality of interactions via a graphical user interface on a client device based on the detected interaction. For example, in one or more embodiments, the act 740 includes, based on an interaction with the adaptive card, presenting the plurality of interactions based on the instructions from the walkthrough file via a graphical user interface of the application on the client device.

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
receiving, at an administrator device, a request for assistance in performing a task on an application, the request for assistance originating from a client device;
recording a plurality of interactions on the administrator device in connection with performing the task, the plurality of interactions including a sequence of inputs comprising one or more clicks and one or more keystrokes at corresponding locations on a graphical user interface of the application;
generating a walkthrough file executable on the client device, the walkthrough file comprising information that indicates the recorded plurality of interactions associated with performing the task; and
causing information from the walkthrough file to be provided to the client device for presenting the plurality of interactions via a the graphical user interface of the application on the client device, wherein presenting the plurality of interactions includes simultaneously presenting a plurality of graphical elements associated with each interaction of the plurality of interactions, each of the plurality of graphical elements including one or more of a click indicator or a keystroke indicator and an associated sequence of corresponding interactions within the plurality of interactions.

2. The method of claim 1, further comprising establishing a connection between the client device and the administrator device via a chat platform operating in conjunction with the application on the client device, wherein the request for assistance in performing the task is received from the client device via the chat platform.

3. The method of claim 1, wherein causing the walkthrough file to be provided comprises providing an adaptive card including one or more selectable options associated with providing one or more corresponding presentations of the plurality of interactions via the graphical user interface of the application.

4. The method of claim 3, wherein the one or more selectable options comprises:
a first selectable option associated with a first presentation of the plurality of interactions in which the plurality of interactions is executed on the client device without detecting inputs associated with the plurality of interactions from a user of the client device; and
a second selectable option associated with a second presentation of the plurality of interactions in which instructional indicators for each interaction of the plurality of interactions are provided via the graphical user interface of the application on the client device.

5. The method of claim 1, wherein recording the plurality of interactions comprises tracking a series of inputs by a user of the administrator device.

6. The method of claim 5, wherein recording the plurality of interactions further comprises tracking a location of the series of inputs on the graphical user interface of the application on the administrator device.

7. The method of claim 1, wherein generating the walkthrough file includes generating a JavaScript Object Notation (JSON) object including the information from the walkthrough file, wherein the information from the walkthrough file includes instructions executable on the client device for presenting the plurality of interactions via the graphical user interface of the application on the client device.

8. The method of claim 1, wherein generating the walkthrough file comprises:
providing the recorded plurality of interactions to a customer service platform; and
receiving an identifier of the walkthrough file generated by the customer service platform to provide to the client device.

9. The method of claim 1, wherein the application comprises one or more of:
a web application hosted by a web server and presented on the client device; or a local application stored on the client device.

10. The method of claim 1, further comprising:
causing a copy of the walkthrough file to be stored on a database including a plurality of walkthrough files associated with respective tasks for the application; and
in response to receiving a subsequent request for assistance in performing the task on the application on an additional client device, providing the walkthrough file to the additional client device for presenting of the plurality of interactions via a graphical user interface of the application on the additional client device.

11. A method, comprising:
providing, to an administrator device via a chat platform, a request for assistance in performing a task on an application on a client device;
receiving, from the administrative device via the chat platform, an adaptive card including one or more links to instructions from a walkthrough file, wherein the instructions are executable on the client device to cause the client device to present a plurality of interactions for performing the task;
based on an interaction with the adaptive card, presenting the plurality of interactions based on the instructions from the walkthrough file via a graphical user interface of the application on the client device
monitoring interactions by a user of the client device in connection with presenting the plurality of interactions of the walkthrough file to determine whether one or more interactions from the plurality of interactions are performed correctly; and
based on whether one or more interactions from the plurality of interactions of the walkthrough file are performed correctly, providing a first indicator associated with an incorrect input or a second indicator associated with a correct input.

12. The method of claim 11, wherein providing the request comprises providing information associated with the task and the application for use in identifying the administrator device having access to the application.

13. The method of claim 11, wherein the one or more links include a selectable link to the instructions of the walkthrough file that, when executed on the client device, cause the client device to present the plurality of interactions via the graphical user interface of the application on the client device without detecting inputs corresponding to the plurality of interactions from a user of the client device.

14. The method of claim 11, wherein the one or more links include a selectable link to the instructions of the walkthrough file that, when executed on the client device, cause the client device to provide a series of instructional indicators at locations within the graphical user interface of the application on the client device corresponding to locations of the plurality of interactions when recorded on the administrator device or another administrator device.

15. The method of claim 14, wherein providing the series of instructional indicators comprises:
providing a first instructional indicator at a first location within the graphical user interface of the application on the client device; and
providing, in response to detecting a first interaction with the client device at the first location in accordance with the first instructional indicator, a second instructional indicator at a second location within the graphical user interface of the application on the client device.

16. The method of claim 11, wherein the one or more links include:
a first selectable link to first instructions of the walkthrough file that, when executed on the client device, cause the client device to present the plurality of interactions via the graphical user interface of the application without receiving input corresponding to the plurality of interactions from a user of the client device; and
a second selectable link to second instructions of the walkthrough file that, when executed on the client device, cause the client device to provide a series of instructional indicators at locations within the graphical user interface of the application on the client device associated with performing the task.

17. A system, comprising:
one or more processors;
memory in electronic communication with the one or more processors; and
instructions stored in the memory, the instructions being executable by the one or more processors to:
receive, at an administrator device, a request for assistance in performing a task on an application, the request for assistance originating from a client device;
record a plurality of interactions on the administrator device in connection with performing the task, the plurality of interactions including a sequence of inputs comprising one or more clicks and one or more keystrokes at corresponding locations on a graphical user interface of the application;
generate a walkthrough file executable on the client device, the walkthrough file comprising information that indicates the recorded plurality of interactions associated with performing the task; and
cause information from the walkthrough file to be provided to the client device for presenting the plurality of interactions via the graphical user interface of the application on the client device, wherein presenting the plurality of interactions includes simultaneously presenting a plurality of graphical elements associated with each interaction of the plurality of interactions, each of the plurality of graphical elements including one or more of a click indicator or a keystroke indicator and an associated sequence of corresponding interaction within the plurality of interactions.

18. The system of claim 17, wherein causing information from the walkthrough file to be provided comprises providing an adaptive card including one or more selectable options associated with providing one or more corresponding presentations of the plurality of interactions via the graphical user interface of the application.

19. The system of claim 18, wherein the one or more selectable options comprises:
a first selectable option associated with a first presentation of the plurality of interactions in which the plurality of interactions is executed on the client device without detecting inputs associated with the plurality of interactions from a user of the client device; and
a second selectable option associated with a second presentation of the plurality of interactions in which instructional indicators for each interaction of the plurality of interactions are provided via the graphical user interface of the application on the client device.

20. The system of claim 17, wherein recording the plurality of interactions comprises tracking a series of inputs by a user of the administrator device and locations of the series of inputs on the graphical user interface of the application on the administrator device.
